(19) United States
(12) Patent Application Publication
(10) Pub. No.: US 2019/0145169 A1
(43) Pub. Date: May 16, 2019

(54) PASSAGE CONTROL DEVICE FOR PERSONS

(71) Applicant: Magnetic Autocontrol GmbH, Schopfheim (DE)

(72) Inventors: Nico Marquart, Freiburg (DE); Cvjetko Trivunovic, Weil am Rhein (DE)

(73) Assignee: Magnetic Autocontrol GmbH, Schopfheim (DE)

(21) Appl. No.: 16/189,162

(22) Filed: Nov. 13, 2018

(30) Foreign Application Priority Data
Nov. 14, 2017 (DE) 102017126765.4

(51) Int. Cl. E06B 11/08; G07C 9/02; G07C 9/00

(52) U.S. Cl. CPC E06B 11/08; G07C 9/025; G07C 9/00103; G07C 9/00166; G07C 9/00031; G07C 9/00134

(57) ABSTRACT

A passage control device for persons is provided, including at least one housing, at least one blocking element held so as to be movable relative to the housing, a drive, arranged substantially in the housing, for blocking and releasing and/or moving the at least one blocking element, and a control unit for the drive, which acts in combination with a control element for identifying an authorization, and which controls the drive in accordance with the authorization, in order either to block or release, and/or to move, the blocking element. The housing is constructed having a frame element formed substantially of a plastic or a plastic composite material, having a support structure, arranged inside the frame element, for the blocking element and the drive, and having a rear and a front cover plate, which are formed substantially of a plastic or a plastic composite material and fastened to the frame element.

### INCORPORATION BY REFERENCE

The following documents are incorporated herein by reference as if fully set forth: German Patent Application No. DE 102017126765.4, filed Nov. 14, 2017.

### BACKGROUND

The present invention relates to a passage control device for persons.

Such a passage control device accordingly comprises at least one housing, at least one blocking element held so as to be movable relative to the housing, a drive, arranged substantially in the housing, for blocking and releasing and/or moving the blocking element, and a control unit for the drive, which acts in combination with a control element for identifying an authorization. The control unit controls the drive in accordance with the authorization, in order either to block or release, and/or to move, the blocking element.

Passage control devices of the present type are in widespread use. They are normally used to monitor and regulate access to protected regions for which a specific authorization is required, such as, for example, access to a works premises, access to sports facilities such as stadiums, swimming pools and the like, for which payment of an entry fee is required, access to safety regions at airports, access to underground railway stations, access to public toilet facilities, and so forth. For this purpose, the passage control device includes a blocking element, which either releases or blocks passage for persons, specifically in dependence on a specific authorization of the respective person. The authorization may be the paying of an entry fee, the showing or placing or entering of a ticket and/or identification card, the identifying of biometric data or the keying-in of a number code.

If the control element for identifying an authorization ascertains that the person standing in front of the blocking element possesses an authorization that entitles the person to pass, the blocking element is released, such that the person can go through; this is usual in the case of turnstiles and rotor gates. If necessary, the blocking element is not only released by the drive, but is actively moved, to allow the authorized person to pass; this is usual in the case of barrier systems and passage control devices having swivelable doors. Accordingly, the drive of the present passage control device may be purely an actuator for blocking and unblocking the blocking element, or also a motor for actively moving the blocking element.

The housing of a passage control device of the present type accommodates the drive and forms the support for the blocking element. Accordingly, it must have a high degree of robustness, such that a blocking element cannot be moved in an unauthorized manner in order to force a passage. At the same time, the housing is normally realized so as to be elongate along a passage direction, such that, together with a housing of a second, adjacent passage control device, or a wall element, a corridor is formed in front of the blocking element. This corridor ensures that persons passing through can only approach the blocking element singly.

The requirements for the robustness of the housing, and the above-mentioned feature intended for it, of forming a corridor, result in the housing taking up a lot of space in comparison with the actual blocking element, i.e. the outer surfaces of the housing have to be comparatively extensive. Since the walls of the housing are usually made from stainless steel, the result is correspondingly high costs for the housing and a disadvantageously heavy weight.

However, in view of the high mechanical surface loads caused by a multiplicity of persons passing through, who are possibly also passing the blocking element with bags and the like, it is scarcely possible to find a replacement for the material stainless steel. This is because plastics or plastic composite materials, with which the stainless steel surfaces could be replaced, still cannot have the inherently robust properties of stainless steel, such that hitherto it has not been considered to produce the housing of a passage control device of the present type substantially from plastic or a plastic composite material.

### SUMMARY

The present invention is therefore based on the object of developing a passage control device such that the material stainless steel, used hitherto for the housing, can be largely replaced by plastic or a plastic composite material.

This object is achieved with a passage control device having the one or more features of the invention. Preferred designs and developments of the passage control device according to the invention are set forth below and in the claims.

A passage control device according to the invention for persons, which comprises at least one housing, at least one blocking element held so as to be movable relative to the housing, a drive, arranged substantially in the housing, for blocking and releasing and/or moving the blocking element, and a control unit for the drive, which acts in combination with a control element for identifying an authorization, and which is designed such that it controls the drive in accordance with the authorization, in order either to block or release, and/or to move, the blocking element, accordingly has a housing, which is constructed having a frame element of a plastic or a plastic composite material, having a support structure, arranged inside the frame element, for the blocking element and the drive, and having a rear and a front cover plate, which are composed substantially of a plastic or a plastic composite material and fastened to the frame element.

The frame design according to the invention enables the housing to be produced substantially from plastic or a plastic composite material, such that it is possible to dispense with the expensive material stainless steel. Very significant savings in weight result in this case, such that the costs for the transport and construction of a passage control device according to the invention are also reduced. In comparison with a stainless steel housing, a plastic housing additionally offers the advantages of a more pleasant feel, a significantly greater design freedom and easier quality assurance during production. Unlike stainless steel, a plastic or plastic composite material does not undergo any lasting deformations in the case of impact stress, and it has an electrically insulating effect, which is highly advantageous for safety reasons. Not least, plastic surfaces are very much easier to clean than stainless-steel surfaces and, owing to its property as a selective absorber, a stainless steel surface can heat up to such an extent under solar radiation that there is a risk of injury to persons; plastic surfaces do not have this problem.

The frame element provided according to the invention, which, due to the usually elongate, wall-type shape of the housing, preferably circumscribes approximately a narrow, elongate rectangular parallelepiped, is able to ensure the robustness of the housing necessary for guiding the persons passing through. This is because a frame element of plastic can be made so as to be solid and robust, for example having a double-T structural-member cross-sectional profile, which renders the housing as a whole flexurally and torsionally stiff, even if the front and rear cover plates attached according to the invention to the frame element are likewise composed of plastic, and accordingly per se are only slightly flexurally and torsionally stiff.

The necessary robustness of the blocking element, on the other hand, is ensured according to the invention by a support structure arranged inside the frame element. This support structure will normally be composed of metal tubes or metal profiles, which absorb the forces that act upon the blocking element, but which, since they are arranged inside the housing, although they do have to be composed of robust materials, nevertheless do not necessarily have be composed of high-grade materials having insensitive surfaces.

It has thus been identified according to the invention that the robustness requirements of a passage control device of the present type can be modified by separate consideration of the acting forces: on the one hand, forces acting upon the blocking element are passed into the housing, and on the other hand the housing must withstand directly applied forces. These forces can be absorbed by different elements of the housing. Due to the housing structure according to the invention by which, on the one hand, the robustness of the housing per se is achieved by a frame design, and by which, on the other hand, the forces acting upon the blocking element are substantially absorbed by an additional support structure, for the first time it is possible to produce the majority of the housing of a passage control device from plastic or a plastic composite material. This brings considerable cost advantages.

Preferably, the support structure for the blocking element and the drive extends as far as a base of the housing, and can be directly connected there to the floor on which the passage control device according to the invention is installed. The forces that act upon the blocking element are thus passed substantially directly into the floor mounting, and are otherwise absorbed by the support structure, without the forces necessarily being passed into the frame element of the housing.

A further problem in the case of passage control devices according to the prior art consists in that—depending on their purpose—they are sited, without monitoring by personnel, at publically accessible locations of a blocked-off region, and are thus subjected to manipulation attempts. The housing of a passage control device must therefore not be easily opened from the outside without application of force, in particular not with the use of simple tools that are in common use and carried on the person, for example as a pocket knife or multifunctional tool. Housings of known passage control devices are therefore provided in some cases with locks and in some cases with fastening elements that require the use of a special tool; this is because it must nevertheless be possible to open the housing for servicing purposes or in the event of a malfunction.

A preferred development of the present invention simplifies the protection of the housing against unauthorized opening, in that at least one of the rear and front cover plates is fastened by snap-in plug-type connections. Only few secure fastening elements, such as screwed connections, which can more easily be protected against manipulations, are then needed.

A particularly advantageous aspect of the passage control device according to the invention, which is non-dependent on the materials used for the housing, is provided in that the housing does not have any externally accessible connection or locking elements.

This is achieved according to the invention in that the rear cover plate of the housing is fastened to the frame element by circumferentially distributed screw connections, the front cover plate is fastened to the frame element and/or to the rear cover plate by circumferentially distributed snap-in plug-type connections, and a recess for the support structure and/or the drive is provided on the front cover plate. This recess is covered with an additional cover, and in a region of the front cover plate, which is likewise covered by the additional cover, at least one screw connection is provided between the front cover plate and the frame element and/or the rear cover plate, in order to secure the screw connection of the front cover plate. The additional cover, for its part, is fastened to the front cover plate and/or to the frame element by snap-in plug-type connections, and according to the invention it is releasable from this plug-type connection only by application of a force that is predefined in respect of application location and direction, or alternatively by a special tool, which must be positioned at the correct location.

Due to this design of the housing, the outside of the latter is entirely without locks or externally accessible fastening elements, such that it is not evident from the outside how the housing can be opened. It is only after removal of the additional cover, which is only possible for a person who knows where a special tool or a particular force must be applied to enable the cover to be released from its snap-in plug-type connections that the screw connections become accessible to enable the front cover plate to be released.

The housing of the passage control device according to the invention is preferably of a relatively narrow design, the frame element forming the side faces and a top face of the housing, while the front and the rear cover plate leave the side faces and the top face free.

It is preferred in this case if the control element for identifying an authorization is arranged at at least one corner of the housing that connects a side face to the top face. This control element may be, for example, a contactless card reader or a scanner for identifying tickets, identification cards or finger-prints and so forth. It is therefore advantageous if it is arranged at an upper corner of the housing that is approached directly by a person passing through, when the person approaches the passage control device.

In order to increase as required the robustness of the housing of the passage control device according to the invention, it may be advantageous if the frame element is reinforced with at least one metal profile in a region in which the support structure extends as far as the base of the housing. Likewise, it may be advantageous if the frame element is reinforced with at least one metal profile at the top face of the housing.

The passage control device according to the invention is preferably designed as a turnstile, known per se, i.e. the blocking element is a turnstile having three blocking arms attached with a rotary angle spacing of approximately 120°. These blocking arms are arranged in the manner of a tripod going out from the housing, or from the drive, i.e. they span a triangular pyramid, wherein, in a blocking position, one blocking arm projects horizontally into the passage, while the other two blocking arms point downward and are rotated out of the passage. A rotational axis that is approximately 45° to the horizontal enables each of the three blocking arms to be brought into the horizontal position by rotation of the blocking element, wherein at the same time a person present at the previously horizontally positioned blocking arm is let through by a rotation of the blocking element.

Alternatively, the blocking element may also comprise at least one door element, which can be swiveled about a vertical axis, and which can be swiveled by the drive out of a blocking position, in which the door element extends into the passage, into a passage position, and back.

As a further alternative, the blocking element may comprises at least one plate element, which can be swiveled, about a horizontal axis, out of the housing and swiveled back into the latter, and which, if appropriate, is realized in the manner of telescopic fan, known per se.

The frame design of the housing according to the invention enables the housing to be used in a modular manner, such that it can be provided with differently designed blocking elements, which are each known per se, such as the already mentioned turnstiles, door elements or plate elements, as well as barrier systems and so forth. Such a modular design of the housing reduces yet further the costs of manufacturing passage control devices for persons.

### BRIEF DESCRIPTION OF THE DRAWINGS

An exemplary embodiment for a passage control device designed according to the invention is described in greater detail in the following on the basis of the appended drawings. There are shown:

FIG. 1 a perspective view of an exemplary embodiment of a passage control device according to the invention, realized as a turnstile;

FIG. 2 an exploded representation of the housing of the passage control device from FIG. 1;

FIG. 3 the passage control device from FIG. 1 without blocking element;

FIG. 4 the passage control device from FIG. 1 with opened housing;

FIG. 5 a further exemplary embodiment of a passage control device designed according to the invention, in a partial representation;

FIG. 6 a third exemplary embodiment of a passage control device designed according to the invention.

### DETAILED DESCRIPTION

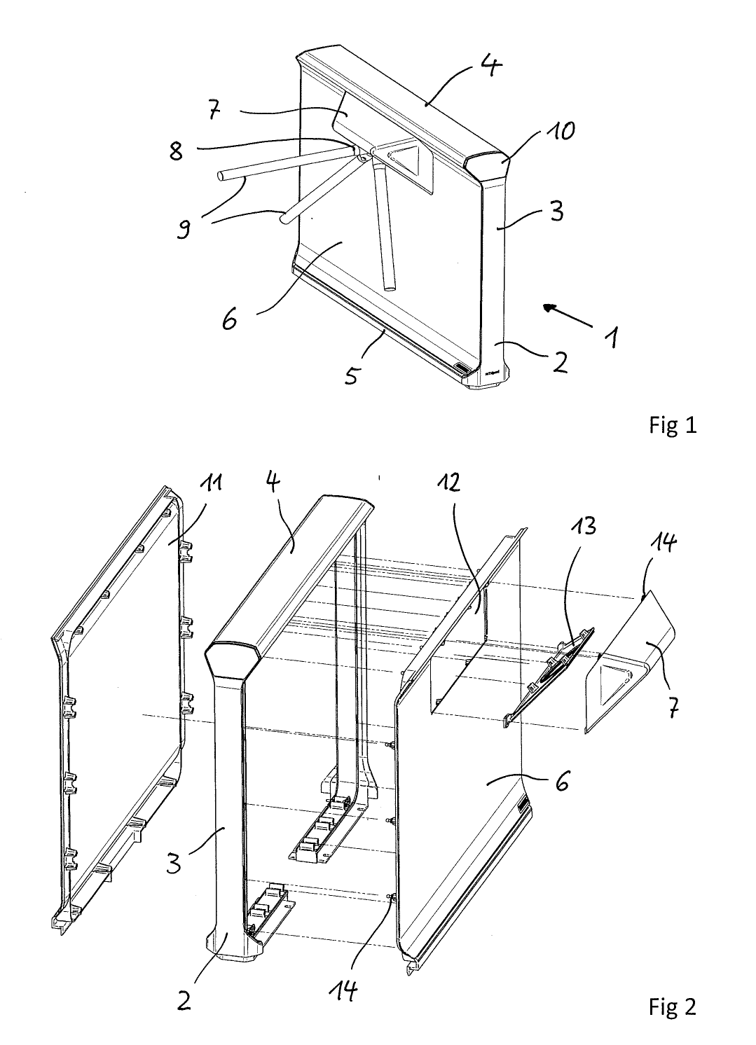

A first exemplary embodiment of a passage control device designed according to the invention is shown in a perspective representation in FIG. 1. Visible in this case are a housing 1, having a frame element 2, which forms two side faces 3 and a top face 4, as well as a base 5 of the housing, a front cover plate 6, which is made from plastic (PU), an additional cover 7, likewise of plastic (PU), and a blocking element 8. The blocking element 8 in the present case is realized as a turnstile having three blocking arms 9, which can rotate about a rotational axis that goes through a point of intersection of the three axes of the blocking arms 9 and that is inclined at approximately 45° to the horizontal. The blocking arms 9 are each spaced apart from each other by 120° in the rotation direction, and span a triangular pyramid, also in each case enclosing between them an angle of approximately 45°. This has the result that, in a blocking position, which is represented in FIG. 1, a blocking arm 9 projects horizontally from the housing 1 and blocks the passage, while the other two blocking arms 9 point vertically downward in a projection in the passage direction, such that they do not obstruct the passage.

Arranged in a connection region between the front side face 3 and the top face 4 is a control element 10, which in the present case is designed as a contactless near-field card reader. Upon approaching the blocking element 8, a person having a card that gives authorization can hold this card to the control element 10 or place the card on it, whereupon a control unit (not visible here) controls a drive (likewise not visible here) under the additional cover 7, such that the drive releases the blocking element 8. The authorized person can then push away the upper, horizontally extending blocking arm 9 in the passage direction, as a result of which all three blocking arms 9 rotate about the common rotational axis and, behind the person who has passed through, the next blocking arm 9 comes upward into the horizontal position. There, the blocking element 8 is again blocked by the drive, in order to prevent an unauthorized passage.

As already mentioned, the front cover plate 6, like the rear cover plate (which is not visible here), is comprised of polyurethane, and can be produced correspondingly inexpensively. The frame element 2 is also made from a plastic, preferably likewise PU, the top surface 4 being color-coated. The control element 10 may simply be integrated into the frame element 2 or placed on the latter inside the housing 1, such that it is correspondingly protected. Since the frame element 2 is made from plastic, it does not impede wireless communication between the control element 10 and a card brought into the proximity thereof from outside.

As can be seen from this representation, the housing 1 has an elongate shape, and thereby forms a wall element of a corridor for persons wishing to pass through the blocking element 8. This corridor has a corresponding singling effect, such that only the respectively authorized person is let through. The dimensions of the outer faces of the housing 1 are of corresponding magnitude, such that the saving in costs and weight is significant, resulting from the fact that all outer faces of the housing 1 are made from plastic, instead of from stainless steel, as was formerly usual.

FIG. 2, in an exploded representation, shows the housing 1 of the passage control device from FIG. 1. Clearly visible is the central frame element 2 according to the invention, made of plastic, which also forms the side faces 3 and the top face 4. Attached thereto are a rear cover plate 11 and the front cover plate 6. The latter is provided with a recess 12, through which the blocking element 8 (omitted here) is connected to a support structure (likewise omitted here) arranged inside the housing 1. A dividing plate 13 in this case covers the drive (not represented) outwardly.

As made clear by FIG. 2, the rear cover plate 11 is fastened to the frame element 2 by circumferentially distributed screw connections. The front cover plate 6, on the other hand, is fastened to the rear cover plate 11 by snap-in plug-type connections 14. The additional cover 7, which is provided to cover the recess 12 in the front cover plate 6, is also fastened by snap-in plug-type connections 14, specifically on the front cover plate 6. These plug-type connections are designed such that the cover 7 can only be separated from the front cover plate 6, without application of excessive force, if a special levering-out tool is applied at the correct location.

This structure of the housing 1 achieves the effect that, in the fully assembled state, the housing 1 does not have any externally accessible fastening elements whatsoever (see FIG. 1).

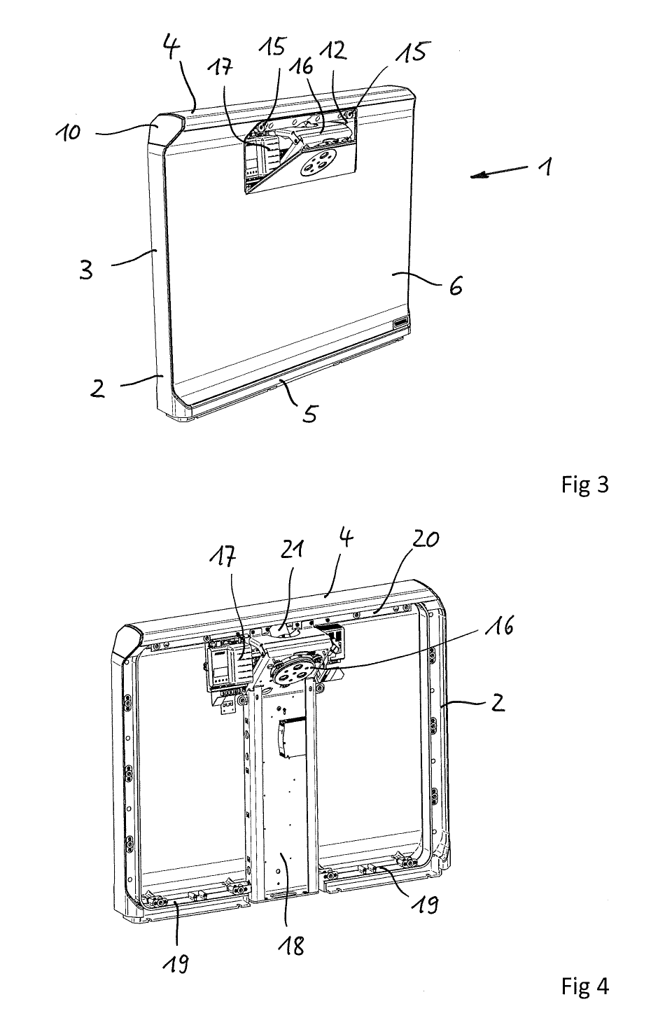

As can be seen from FIG. 3, the front cover plate 6 is by no means merely plugged-in. Rather, beneath the cover 7, which has been omitted here, there are four screw connections 15, which secure the front cover plate 6 to the frame element 2. These screw connections 15, however, are only accessible when the cover 7 has been removed (as represented).

As also shown by FIG. 3, a drive 16 for the blocking arms 9, or the entire blocking element 8, is located behind the dividing plate 13. There is also a control unit 17, integrated into the housing 1.

FIG. 4 shows a view like that of FIG. 3, but in this case the front cover plate 6 has been omitted. This makes clear that the drive 16, and with it the entire blocking element 8, is fastened to a support structure 18, which continues as far as the base 5 of the housing 1, and which passes the forces that act upon the individual blocking arms 9 substantially into the floor mounting of the passage control device. For the purpose of stabilizing, metal profiles 19 are in each case attached to the lower spars of the frame element 2. The support structure 18 itself is also realized as a metal profile.

The support structure 18 is also fastened to the upper spar of the frame element 2, such that a further metal profile 20 is provided there to stiffen the frame element 2. The control unit 17 is seated on a plate that, for its part, is fastened to the support structure 18.

As is furthermore evident from FIG. 4, in the case of the present exemplary embodiment the drive 16 also comprises a motor 21, i.e. the drive is not a mere actuator that releases the blocking element 8 after authorization has been effected and that blocks it again after a person has gone through, but instead the turnstile is moved actively as soon as a person, who has been successfully authorized, pushes against the uppermost blocking arm 9 that extends horizontally into the passage.

Finally, it is also made clear by FIG. 4 that, due to the idea according to the invention, of constructing the housing 1 with a frame structure, i.e. with a frame element 2 made from plastic, and of creating the robustness necessary for the blocking element by a support structure 18 that is integrated into the housing 1 and separate from the frame element 2 per se, and that, although preferably composed of a metal profile or a profile structure or tubular structure, nevertheless does not have to be made of stainless steel, the outer shell of the housing 1 can be made entirely from plastic, which enables significant cost savings to be made in comparison with the material stainless steel used hitherto.

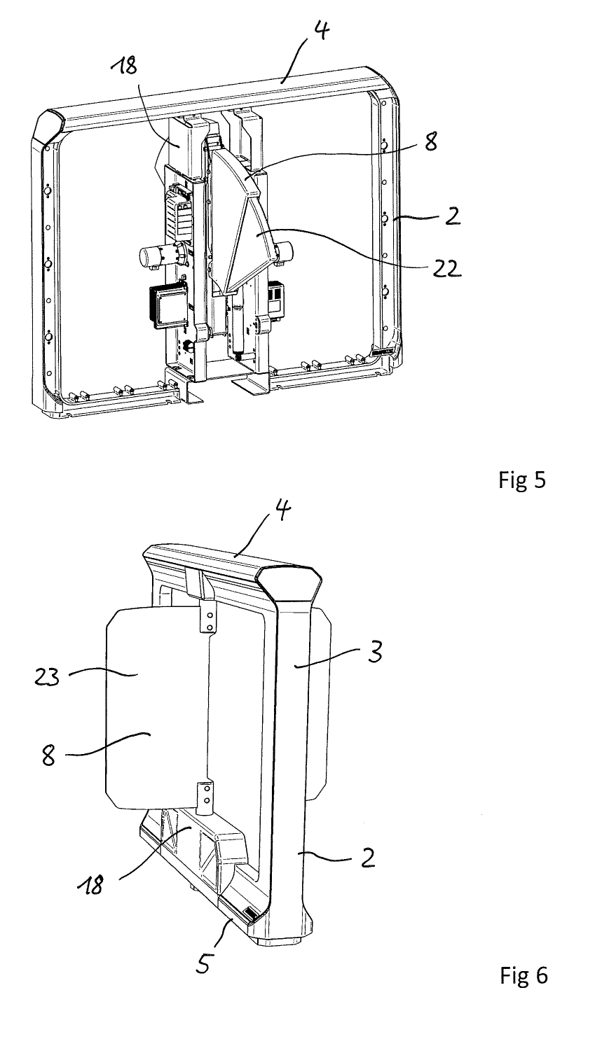

FIG. 5, in a representation corresponding to that of FIG. 4, shows parts of a further exemplary embodiment of a passage control device designed according to the invention. Here again, the same frame element 2 made from plastic is the central part of the housing 1, which is then completed with front and rear cover plates (which are not represented here). However, the blocking element 8, which again is held by a separate support structure 18 integrated in the housing 1, is realized differently. Here, it is a blocking element 8 that comprises a plate element 22, which can be swiveled in a telescoping manner out of the housing and back into the latter. The swivel axis in this case is arranged horizontally and along a passage direction, such that the plate element 22, in the swiveled-out state, blocks the passage, while the passage is released when the plate element 22 is swiveled back into the housing 1.

FIG. 6, finally, shows a view of a third exemplary embodiment for a passage control device designed according to the invention. This is again constructed with the same frame element 2 made from plastic, and a door element 23, which can be swiveled about a vertical axis into and out of the passage, in order to block or release the passage, is provided as a blocking element 8.

It is made clear by FIGS. 5 and 6 that the frame design according to the invention renders possible a modular structure of an entire family of passage control devices, which each realize different blocking elements, or different blocking and release techniques. The possibility of such a modular structure is likewise an advantage of the present invention.

Thus, overall, the present invention enables person passage control devices having differing blocking elements, known per se, the functioning and structure of which are known per se, to be manufactured considerably less expensively than hitherto, and at the same time to improve the design and the security.

1. A passage control device for persons, comprising:
at least one housing (1),
at least one blocking element (8) held so as to be movable relative to the housing (1),
a drive (16), arranged in the housing (1), for at least one of blocking, releasing, or moving the at least one blocking element (8),
a control unit (17) for the drive, that is configured to act in combination with a control element (10) that identifies an authorization and controls the drive (16) in accordance with the authorization, in order either to at least one of block, release, or to move the blocking element (8),
the housing (1) comprises
a frame element (2) comprised substantially of a plastic or a plastic composite material,
a support structure (18) that is arranged inside the frame element (2) for the blocking element (8) and the drive (16), and
a rear cover plate (6) and a front cover plate (11), which are comprised substantially of a plastic or a plastic composite material and fastened to the frame element (2).

2. The passage control device as claimed in claim 1, wherein the support structure (18) extends as far as a base (5) of the housing (1).

3. The passage control device as claimed in claim 2, wherein the support structure (18) is includes at least one metal profile or a tubular structure.

4. The passage control device as claimed in claim 1, wherein at least one of the rear cover plate (6) or the front cover plates (11) is fastened by snap-in plug-type connections (14).

5. The passage control device as claimed in claim 4, wherein the housing (1) does not have any externally accessible connection or locking elements, in that the rear cover plate (11) is fastened to the frame element (2) by circumferentially distributed screw connections, the front cover plate (6) is fastened to at least one of the frame element (2) or to the rear cover plate (11) by circumferentially distributed snap-in plug-type connections (14), and a recess (12) for at least one of the support structure (18) or the drive (16) is provided on the front cover plate (6), said recess is covered with an additional cover (7), at least one screw connection (15) is provided between the front cover plate (6) and at least one of the frame element (2) or the rear cover plate (11), in a region of the front cover plate (6), which is covered by the additional cover (7), and the additional cover (7) is fastened to at least one of the front cover plate (6) or to the frame element (2) by snap-in plug-type connections (14), and said plug-type connections (14) being releasable only by application of a force that is predefined in respect of application location and direction, or by a specific release tool.

6. The passage control device as claimed in claim 1, wherein the frame element (2) forms side faces (3) and a top face (4) of the housing (1).

7. The passage control device as claimed in claim 6, wherein the control element (10) is arranged at least at one corner of the housing (1) that connects a side face (3) to the top face (4).

8. The passage control device as claimed in claim 2, wherein the frame element (2) is reinforced with at least one metal profile (19) in a region in which the support structure (18) extends as far as the base (5) of the housing (1).

9. The passage control device as claimed in claim 1, wherein the frame element (2) is reinforced with at least one metal profile (20) at a top face (4) of the housing (1).

10. The passage control device as claimed in claim 1, wherein the blocking element (8) is a turnstile having three blocking arms (9) attached with a mutual rotary angle spacing of approximately 120°.

11. The passage control device as claimed in claim 1, wherein the blocking element (8) comprises at least one door element (23) that is swivelable about a vertical axis, or at least one plate element (22) that is swivelable about a horizontal axis, out of the housing (1) and back into the housing.

12. The passage control device as claimed in claim 1, wherein the housing (1) is modular and configurable with different types of the blocking elements (8).
